(19) United States
(12) Patent Application Publication
(10) Pub. No.: US 2024/0329928 A1
(43) Pub. Date: Oct. 3, 2024

(54) QUAD NARROWING OPERATION

(71) Applicant: SiFive, Inc., Santa Clara, CA (US)

(72) Inventors: Andrew Waterman, San Mateo, CA (US); Nicholas Knight, Berkeley, CA (US)

(73) Assignee: SiFive, Inc., Santa Clara, CA (US)

(21) Appl. No.: 18/739,757

(22) Filed: Jun. 11, 2024

Related U.S. Application Data
(63) Continuation of application No. PCT/US2022/050843, filed on Nov. 23, 2022.
(60) Provisional application No. 63/290,861, filed on Dec. 17, 2021.

(51) Int. Cl. G06F 7/499

(52) U.S. Cl. CPC G06F 7/49915

(57) ABSTRACT

Systems and methods are disclosed for implementing a quad narrowing operation. The quad narrowing operation converts an output of a 32 bit floating-point operation to the 8 bit integer format by rounding the 32 bit floating-point operation and clamping the rounded 32 bit floating-point input by an 8 bit lower bound and an 8 bit upper bound which are defined in a 16 bit scalar register to generate the fixed-point output. The 8 bit lower bound is defined by the 8 most significant bits of the 16 bit scalar register and the 8 bit upper bound is defined by the 8 least significant bits of the 16 bit scalar register.

### CROSS-REFERENCES TO RELATED APPLICATIONS

This application is a continuation of International Application No. PCT/US2022/050843, filed Nov. 23, 2022, which claims priority to U.S. Provisional Application No. 63/290,861, filed Dec. 17, 2021, the contents of which are incorporated herein by reference in their entirety.

### FIELD OF TECHNOLOGY

This disclosure relates to neural network computations.

### BACKGROUND

Neural networks, also known as artificial neural networks, are widely used in a wide variety of fields. These neural networks consist of an input layer, multiple hidden (computational) layers, and an output layer. A layer may include multiple nodes, and nodes in one layer may be connected to nodes in other layers. A node has an associated weight and threshold. A layer is activated if an output, which is determined based on its associated weight and inputs, of any individual node is above its associated threshold. An activated node sends output to the next layer of the network. Otherwise, no output is sent to the next layer of the network.

A multiplicity of computations are performed at a node to generate the thresholds and the output for that node based on its inputs and weights. The multiplicity of computations require execution of a large number of operations and have strict memory requirements when performed based on floating-point data using floating-point processing units. This may result in high energy consumption or power requirement.

Quantized neural networks decrease the high energy consumption or power requirement by using fixed-point processing units operating on fixed-point data. Operations can be performed using integer rather than floating-point data types. Quantization allows for the conversion of floating-point data types to fixed-point data types, which can reduce the number of bits used to encode the weights and the inputs, for example, in the neural network. Quantization, however, can lead to a loss of accuracy.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an integrated circuit supporting quad narrowing operations.

FIG. 2 is a block diagram of an example of an integrated circuit supporting quad narrowing operations.

FIG. 3 is a memory map of examples of vector memory instructions.

FIG. 4 is a diagram of an example neural network with hybrid floating-point and fixed-point computations for improved neural network accuracy.

FIG. 5 is a flow chart of an example method for a quad narrowing operation.

FIG. 6 is a block diagram of an example of a system for facilitating generation of a circuit representation.

### DETAILED DESCRIPTION

Described herein is a system and method for implementing a quad narrowing operation.

Selective fixed-point operations in a neural network can be replaced with floating-point operations to obtain better accuracy without a substantial increase in processing time. For example, in some implementations of fixed-point units and floating-point units, the effective cost of operating a floating-point unit may not be greater than or substantially greater than operating a fixed-point unit. Thus, it may be beneficial to selectively utilize a floating-point unit instead of a fixed-point unit to obtain a more accurate result where the cost of using the floating-point unit is the same or results in an increase that is less than a certain threshold. These floating point operations are performed using a 32 bit floating bit format. However, the quantized neural networks use 8 bit integer formats for input/output between the different layers in the neural network.

In an aspect, a quad narrowing operation is provided which converts an output of a floating-point operation to the 8 bit integer format. In some implementations, the conversion is to an unsigned 8 bit integer format. In some implementations, the conversion is to a signed 8 bit integer format. The quad narrowing operation clamps or clips a 32 bit floating-point value to a range specified by a 16 bit scalar register. The quad narrowing operation uses 8 bit upper and lower bounds. The value of the upper bound is specified by the 8 least significant bits in the scalar register and the value of the lower bound is specified by the 8 most significant bits in the scalar register. The quad narrowing operation applies a rounding operation to the 32 bit floating-point value and clamps the rounded 32 bit floating-point value using the upper and lower bounds.

In yet another aspect, the quad narrowing operation can be performed in a reduced number of steps in contrast to a standard set of instructions for accomplishing the same computational result.

As used herein, the term “circuit” refers to an arrangement of electronic components (e.g., transistors, resistors, capacitors, and/or inductors) that is structured to implement one or more functions. For example, a circuit may include one or more transistors interconnected to form logic gates that collectively implement a logical function.

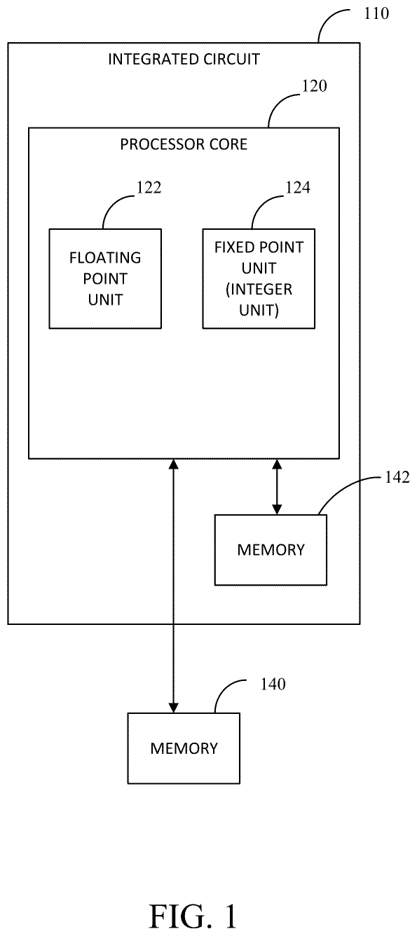

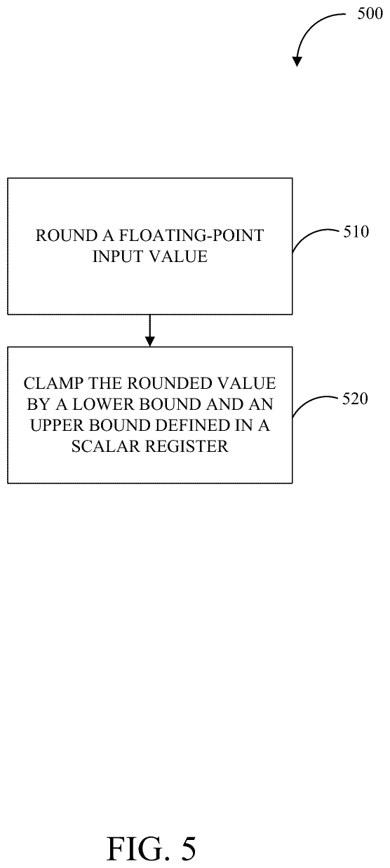

FIG. 1 is a block diagram of an example of an integrated circuit 110 for executing instructions enabling a quad narrowing operation. The integrated circuit 110 includes a processor core 120. The processor core 120 includes a floating-point unit 122 for performing floating-point operations on floating-point data and a fixed-point or integer unit 124 for performing fixed-point operations on fixed-point data. The processor core 120 is configured to fetch instructions from and access data stored in a memory 140 external to the integrated circuit 110 and/or a memory 142 internal to the integrated circuit 110. The integrated circuit 110 may provide advantages over conventional processor architectures, such as, for example, performing a quad narrowing operation with a reduced set of instructions in contrast to using a standard set of instructions for accomplishing the same computational result. For example, the integrated circuit 110 may implement the process 500 of FIG. 5.

The processor core 120 may include a pipeline configured to execute instructions including, but not limited to, floating-point rounding instructions and quad narrowing instructions. The pipeline stages can include for example, fetch, decode, rename, dispatch, issue, execute, memory access, and write-back stages. For example, the processor core 120 may be configured to execute instructions of a RISC V instruction set which includes a RISC-V vector extension instruction set.

The processor core 120 may be configured to fetch instructions from a memory 140 external to the integrated circuit 110 that stores instructions and/or data. The processor core 120 may be configured to access data in the memory 140 in response to instructions, including, but not limited to, vector instructions (e.g., the vector load instruction 310 or the vector store instruction 330). For example, the processor core 120 may access data in the memory directly or via one or more caches. The processor core 120 may also be configured to fetch instructions from a memory 142 internal to the integrated circuit 110 that stores instructions and/or data. The processor core 120 may be configured to access data in the memory 142 in response to instructions, including, but not limited to, floating-point rounding instructions and quad narrowing instructions. Although not shown in FIG. 1, the integrated circuit 110 may include multiple processor cores in some implementations.

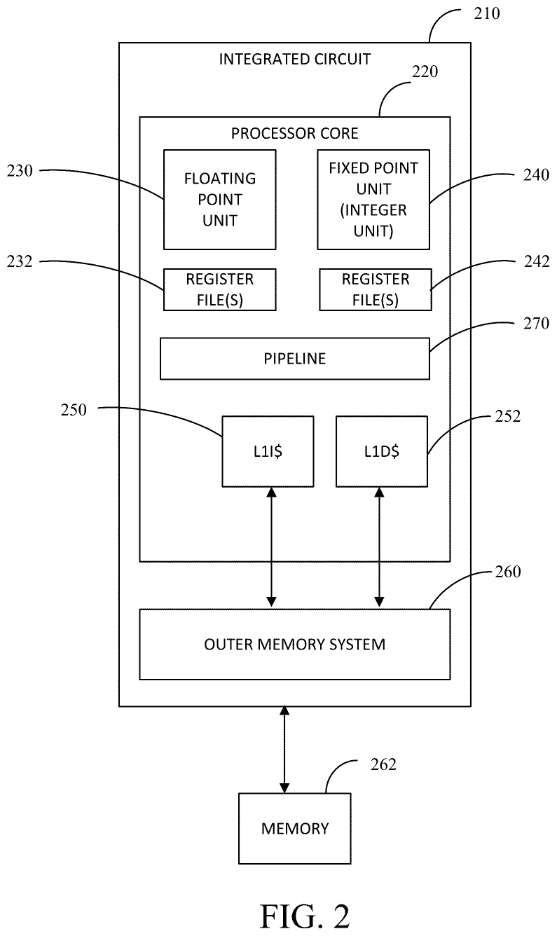

FIG. 2 is a block diagram of an example of an integrated circuit 210 for executing instructions for a quad narrowing operation. The integrated circuit 210 includes a processor core 220. The processor core 220 includes a floating-point unit 230 which is allocated floating-point registers 232 and a fixed-point or integer unit 240 which is allocated fixed-point registers 242. The processor core 220 includes an L1 instruction cache 250 and an L1 data cache 252. The integrated circuit 210 includes an outer memory system 260, which may include memory storing instructions and data and/or provide access to a memory 262 external to the integrated circuit 210 that stores instructions and/or data. The integrated circuit 210 may provide advantages over conventional processor architectures, such as, for example, enabling use of hybrid floating-point and fixed-point computations for improved neural network accuracy and performing a quad narrowing operation with a reduced set of instructions in contrast to using a standard set of instructions for accomplishing the same computational result. For example, the integrated circuit 210 may implement the process 500 of FIG. 5.

The integrated circuit 210 includes a processor core 220 including a pipeline 270 configured to execute instructions, including, but not limited to, floating-point rounding instructions and quad narrowing instructions. The pipeline 270 includes one or more fetch stages that are configured to retrieve instructions from a memory system of the integrated circuit 210. For example, the pipeline 270 may fetch instructions via the L1 instruction cache 250. The pipeline 230 may include additional stages, such as decode, rename, dispatch, issue, execute, memory access, and write-back stages. For example, the processor core 220 may include a pipeline 270 configured to execute instructions of a RISC V instruction set which includes a RISC-V vector extension instruction set.

The floating-point registers 232 and the fixed-point registers 242 may store part or all or an architectural state of the processor core 220. For example, the floating-point registers 232 and the fixed-point registers 242 may include a set of vector registers, as appropriate and applicable. For example, the floating-point registers 232 and the fixed-point registers 242 may include a set of control and status registers (CSRs), as appropriate and applicable. For example, the floating-point registers 232 and the fixed-point registers 242 may include a set of scalar registers, as appropriate and applicable.

The L1 instruction cache 250 may be a set-associative cache for instruction memory. To avoid the long latency of reading a tag array and a data array in series, and the high power of reading the arrays in parallel, a way predictor may be used. The way predictor may be accessed in an early fetch stage and the hit way may be encoded into the read index of the data array. The tag array may be accessed in later fetch stage and may be used for verifying the way predictor.

The L1 data cache 252 may be a set-associative virtually indexed physically tagged (VIPT) cache, meaning that it is indexed purely with virtual address bits VA [set] and tagged fully with all translate physical address bits PA [msb: 12]. For low power consumption, the tag and data arrays may be looked up in serial so that at most a single data static random-access memory (SRAM) way is accessed. For example, the line size of the L1 data cache 252 may be 64 Bytes, and the beat size may be 26 Bytes.

The integrated circuit 210 includes the outer memory system 260, which may include memory storing instructions and data and/or provide access to the memory 262 external to the integrated circuit 210 that stores instructions and/or data. For example, the outer memory system 260 may include an L2 cache, which may be configured to implement a cache coherency protocol/policy to maintain cache coherency across multiple L1 caches. Although not shown in FIG. 2, the integrated circuit 210 may include multiple processor cores in some implementations. For example, the outer memory system 260 may include multiple layers.

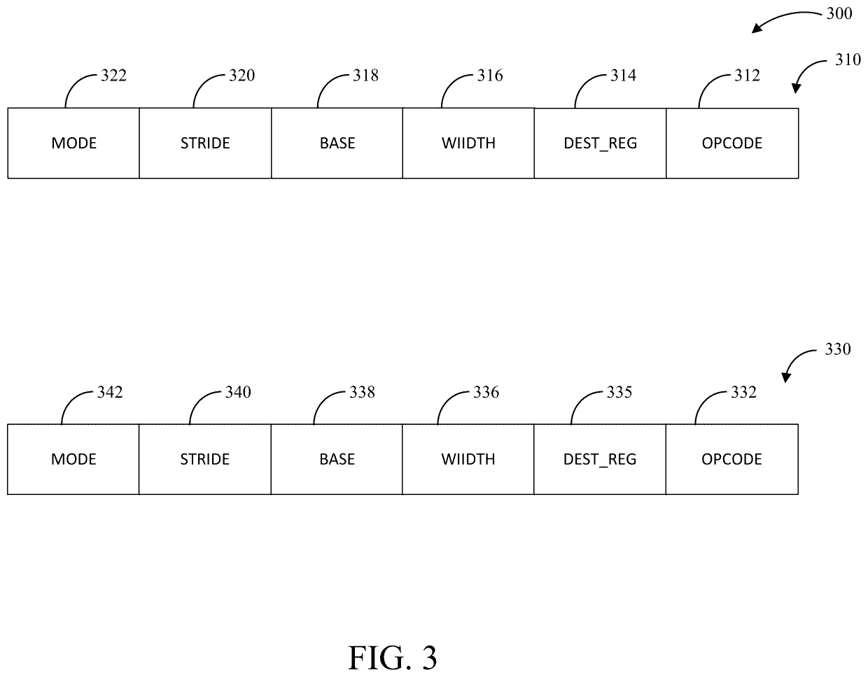

FIG. 3 is a memory map of examples of vector memory instructions 300 that includes a vector load instruction 310 and a vector store instruction 330. For example, in a RISC-V processor core, the vector load instruction 310 may be a LOAD-FP instruction with a vector encoding extension and the vector store instruction 330 may be a STORE-FP instruction a vector encoding extension.

The vector load instruction 310 includes an opcode 312, a destination register field 314 that identifies an architectural register to be used to store a result of the vector load instruction 310, a width field 316 that specifies the size of memory elements of a vector being loaded from memory, a base register field 318 that identifies an architectural register that stores a base address for the vector in memory, a stride register field 320 that identifies an architectural register that stores a stride (e.g., one for a unit-stride vector load or another constant stride) for the vector in memory, and a mode field 322 that specifies additional or optional parameters (e.g., including a memory addressing mode and/or a number of fields in each segment) for the vector load instruction 310.

The vector store instruction 330 includes an opcode 332, a source register field 334 that identifies an architectural register holding vector data for storage, a width field 336 that specifies the size of memory elements of a vector being stored in memory, a base register field 338 that identifies an architectural register that stores a base address for the vector in memory, a stride register field 340 that identifies an architectural register that stores a stride for the vector in memory, and a mode field 342 that specifies additional or optional parameters (e.g., including a memory addressing mode and/or a number of fields in each segment) for the vector store instruction 330.

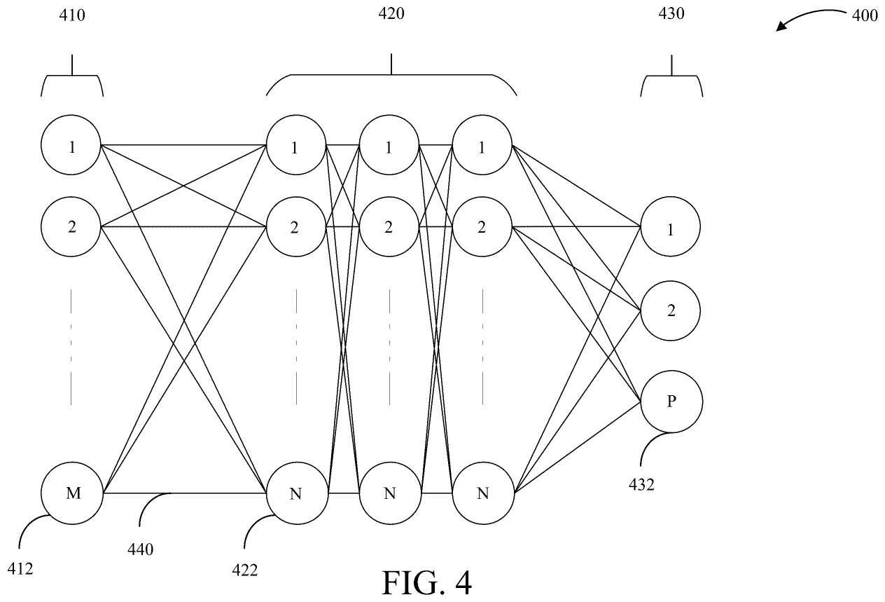

FIG. 4 is a diagram of an example neural network 400 implemented using hybrid floating-point and fixed-point computations for improved neural network accuracy. The neural network includes an input layer 410, hidden layers 420, and an outer layer 430. Each layer of the neural network 400 includes nodes. For example, the input layer 410 includes nodes 1, 2, . . . . M 412, each hidden layer 420 includes nodes 1, 2, . . . . N 422, and the outer layer 430 includes node 1, 2, . . . . P 432. Nodes in one layer are connected to nodes in other layers via edges 440. The nodes can be fully connected (as shown in FIG. 4) or partially connected. A layer can perform or represent certain types of neural network computations including, but not limited to, convolutional layers, pooling layers, and Rectified Linear Unit (ReLU) layers. A node includes a representation of a mathematical operation. Each node has an associated weight and threshold. A layer is activated if an output, which is determined based on its associated weight and inputs, of any individual node is above its associated threshold. An activated node sends output to the next layer of the neural network. Otherwise, no output is sent to the next layer of the neural network.

The neural network 400 uses an 8 bit fixed-point or integer data format for input/output between the layers in the neural network 400. A reason for using the 8 bit integer data format is that neural networks computations done in the neural network 400, at the layers such as the input layer 410, the hidden layers 420, or the outer layer 430, or at the nodes such as the nodes 1, 2, . . . . M 412, the nodes 1, 2, . . . . N 422, or the node 1, 2, . . . . P 432, are done by fixed-point units, such as fixed-point or integer unit 124 or fixed-point or integer unit 240, using fixed-point data. Fixed-point units are used, in part, to reduce high energy consumption or power requirements. However, this may lead to a loss of accuracy in the output from the neural network.

Selective fixed-point operations in a neural network are replaced with floating-point operations based on replacement criteria to obtain better computational accuracy at minimal computational cost. The replacement criteria are based, in part, on increased computational accuracy, negligible computational cost difference, and other factors, for example. They are used to identify nodes and/or layers where fixed-point computations can be replaced by floating-point computations. In some implementations, each layer uses the same replacement criteria. In some implementations, each layer uses a different replacement criteria. In some implementations, same layer types use the same replacement criteria. In some implementations, different layer types use different replacement criteria.

The replacement floating-point operations generate the output in a floating-point data format. For example, the floating point operations are performed and output in a 32 bit floating bit format. However, the quantized neural networks use 8 bit integer formats for input/output between the different layers in the neural network.

In an example, the replacement criteria can identify where there are stack-ups of fixed-point approximations (“computational stacking”). Stacked approximations can amplify or build up less significant inaccuracies into more relevant inaccuracies. By replacing intermediate fixed-point computations with floating-point computations, the inaccuracies from earlier fixed-point computations are mitigated. The output, however, is in a 32 bit floating bit format.

In another example, the replacement criteria can identify instances when an output is greater than a defined output range. In some implementations, nodes comprising a layer in the neural network 400 each perform one or more neural network computations to combine multiple inputs to generate an output. In some implementations, the one or more neural network computations are performed by fixed-point units using fixed-point data inputs to generate the output. In some implementations, the one or more neural network computations are performed by floating-point units using floating-point data inputs to generate the output. In these instances, the output has a dynamic range greater than a defined output range (e.g., defined by an 8 bit integer data format). The output has to undergo processing to align the dynamic range of the output with the defined output range. This processing is performed using a floating-point unit. The processing can include quantization of the output. The quantized output, however, is in a 32 bit floating bit format.

A quad narrowing operation is provided which converts the output of a floating-point operation or the replacement floating-point operation to the 8 bit integer format. In some implementations, the conversion is to an unsigned 8 bit integer format. In some implementations, the conversion is to a signed 8 bit integer format.

The quad narrowing operation clamps or clips a 32 bit floating-point value to lower and upper bounds specified by a 16 bit scalar register. The lower bound is specified by the 8 most significant bits in the scalar register. That is, bits 15-8 in the 16 bit scalar register. The upper bound is specified by the 8 least significant bits in the scalar register. That is, bits 7-0 in the 16 bit scalar register. In some implementations, the lower bound is sometimes statically known to be zero. Placement of the upper bound in the lower bits of the scalar register can reduce instruction count. The lower and upper bounds are of the same signedness as the output of the quad narrowing operation. The quad narrowing operation applies a rounding operation to the 32 bit floating-point value and clamps the rounded 32 bit floating-point value using the upper and lower bounds. In some implementations, the rounding type is set in accordance with a dynamic floating-point rounding mode (e.g., frm in the RISC-V instruction set).

In some implementations, the quad narrowing operation can be expressed as:

max(f[rs1][15:8],min(round(vs2[i]),f[rs1][7:0])) Example Instruction (1)

where f[rs1] is the scalar register specifying the upper and lower bounds, vs2 is a vector register for the 32 bit floating-point input, and round is defined by a value in frm. By implication, if the lower bound is greater than the upper bound, the output or result equals the lower bound. In implementations, the usage of max and min in the Example Instruction (1) is commutative. The quad narrowing operation as expressed can be used in the RISC-V Vector extension (RVV) with standard RVV decoding logic (i.e., no additional decode logic is needed to decode the quad narrowing instruction).

FIG. 5 is a flow chart of an example of a process 500 for implementing a quad narrowing operation. The process 500 includes rounding 510 a floating-point input value; and clamping 520 the rounded value by a lower bound and an upper bound defined in a scalar register. The process 500 can be implemented using the integrated circuit 110 of FIG. 1, the integrated circuit 210 of FIG. 2, and in or with the neural network 400 of FIG. 4.

The process 500 includes rounding 510 a floating-point input value. The quad narrowing operation intakes a floating-point input value and applies a rounding function. The rounding function is dynamically set. The floating-point input value can be a 32 bit floating-point value. The 32 bit floating-point input value can be a quantized 32 bit floating-point input value from a neural network computation. In some implementations, the floating-point input value is a 32 bit floating-point vector input. In implementations, the quad narrowing operation is performed by a floating-point execution unit.

The process 500 includes clamping 520 the rounded value by a lower bound and an upper bound defined in a scalar register. In some implementations, the scalar register is a 16 bit scalar register. The lower bound is defined by the 8 most significant bits of the scalar register and the upper bound is defined by the 8 least significant bits of the scalar register. The clamping outputs a fixed-point value. In some implementations, the fixed-point value is a 8 bit integer value, a signed 8 bit integer value, or an unsigned 8 bit integer value.

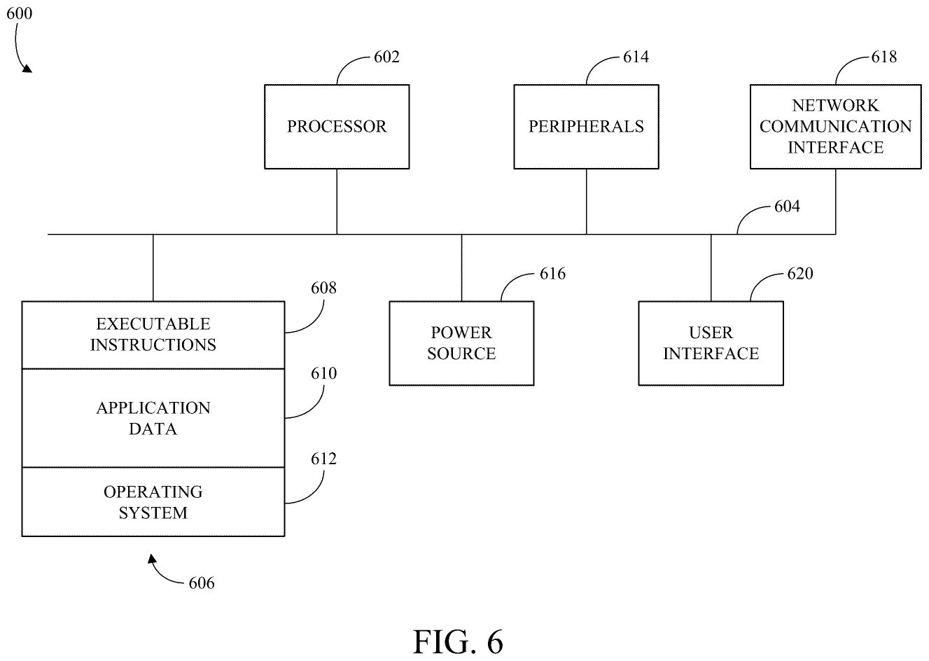

FIG. 6 is a block diagram of an example of a system 600 for facilitating generation of a circuit representation, and/or for programming or manufacturing an integrated circuit. The system 600 is an example of an internal configuration of a computing device. For example, the system 600 may be used to generate a file that generates a circuit representation of an integrated circuit (e.g., the integrated circuit 110 and/or 210), including a processor core (e.g., the processor core 120 and/or the processor core 220) The system 600 can include components or units, such as a processor 602, a bus 604, a memory 606, peripherals 614, a power source 616, a network communication interface 618, a user interface 620, other suitable components, or a combination thereof.

The processor 602 can be a central processing unit (CPU), such as a microprocessor, and can include single or multiple processors having single or multiple processing cores. Alternatively, the processor 602 can include another type of device, or multiple devices, now existing or hereafter developed, capable of manipulating or processing information. For example, the processor 602 can include multiple processors interconnected in any manner, including hardwired or networked, including wirelessly networked. In some implementations, the operations of the processor 602 can be distributed across multiple physical devices or units that can be coupled directly or across a local area or other suitable type of network. In some implementations, the processor 602 can include a cache, or cache memory, for local storage of operating data or instructions.

The memory 606 can include volatile memory, non-volatile memory, or a combination thereof. For example, the memory 606 can include volatile memory, such as one or more dynamic random access memory (DRAM) modules such as double data rate (DDR) synchronous DRAM (SDRAM), and non-volatile memory, such as a disk drive, a solid-state drive, flash memory, Phase-Change Memory (PCM), or any form of non-volatile memory capable of persistent electronic information storage, such as in the absence of an active power supply. The memory 606 can include another type of device, or multiple devices, now existing or hereafter developed, capable of storing data or instructions for processing by the processor 602. The processor 602 can access or manipulate data in the memory 606 via the bus 604. Although shown as a single block in FIG. 6, the memory 606 can be implemented as multiple units. For example, a system 600 can include volatile memory, such as random access memory (RAM), and persistent memory, such as a hard drive or other storage.

The memory 606 can include executable instructions 608, data, such as application data 610, an operating system 612, or a combination thereof, for immediate access by the processor 602. The executable instructions 608 can include, for example, one or more application programs, which can be loaded or copied, in whole or in part, from non-volatile memory to volatile memory to be executed by the processor 602. The executable instructions 608 can be organized into programmable modules or algorithms, functional programs, codes, code segments, or combinations thereof to perform various functions described herein. For example, the executable instructions 608 can include instructions executable by the processor 602 to cause the system 600 to automatically, in response to a command, generate an integrated circuit design and associated test results based on a design parameters data structure. The application data 610 can include, for example, user files, database catalogs or dictionaries, configuration information or functional programs, such as a web browser, a web server, a database server, or a combination thereof. The operating system 612 can be, for example, Microsoft Windows, macOSx, or LinuxR; an operating system for a small device, such as a smartphone or tablet device; or an operating system for a large device, such as a mainframe computer. The memory 606 can comprise one or more devices and can utilize one or more types of storage, such as solid-state or magnetic storage.

The peripherals 614 can be coupled to the processor 602 via the bus 604. The peripherals 614 can be sensors or detectors, or devices containing any number of sensors or detectors, which can monitor the system 600 itself or the environment around the system 600. For example, a system 600 can contain a temperature sensor for measuring temperatures of components of the system 600, such as the processor 602. Other sensors or detectors can be used with the system 600, as can be contemplated. In some implementations, the power source 616 can be a battery, and the system 600 can operate independently of an external power distribution system. Any of the components of the system 600, such as the peripherals 614 or the power source 616, can communicate with the processor 602 via the bus 604.

The network communication interface 618 can also be coupled to the processor 602 via the bus 604. In some implementations, the network communication interface 618 can comprise one or more transceivers. The network communication interface 618 can, for example, provide a connection or link to a network, via a network interface, which can be a wired network interface, such as Ethernet, or a wireless network interface. For example, the system 600 can communicate with other devices via the network communication interface 618 and the network interface using one or more network protocols, such as Ethernet, transmission control protocol (TCP), Internet protocol (IP), power line communication (PLC), Wi-Fi, infrared, general packet radio service (GPRS), global system for mobile communications (GSM), code division multiple access (CDMA), or other suitable protocols.

A user interface 620 can include a display; a positional input device, such as a mouse, touchpad, touchscreen, or the like; a keyboard; or other suitable human or machine interface devices. The user interface 620 can be coupled to the processor 802 via the bus 604. Other interface devices that permit a user to program or otherwise use the system 600 can be provided in addition to or as an alternative to a display. In some implementations, the user interface 620 can include a display, which can be a liquid crystal display (LCD), a cathode-ray tube (CRT), a light emitting diode (LED) display (e.g., an organic light emitting diode (OLED) display), or other suitable display. In some implementations, a client or server can omit the peripherals 614. The operations of the processor 602 can be distributed across multiple clients or servers, which can be coupled directly or across a local area or other suitable type of network. The memory 606 can be distributed across multiple clients or servers, such as network-based memory or memory in multiple clients or servers performing the operations of clients or servers. Although depicted here as a single bus, the bus 604 can be composed of multiple buses, which can be connected to one another through various bridges, controllers, or adapters.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In some implementations, the circuit representation may take the form of a hardware description language (HDL) program, a register-transfer level (RTL) data structure, a flexible intermediate representation for register-transfer level (FIRRTL) data structure, a Graphic Design System II (GDSII) data structure, a netlist, or a combination thereof. In some implementations, the integrated circuit may take the form of a field programmable gate array (FPGA), application specific integrated circuit (ASIC), system-on-a-chip (SoC), or some combination thereof. A computer may process the circuit representation in order to program or manufacture an integrated circuit, which may include programming a field programmable gate array (FPGA) or manufacturing an application specific integrated circuit (ASIC) or a system on a chip (SoC). In some implementations, the circuit representation may comprise a file that, when processed by a computer, may generate a new description of the integrated circuit. For example, the circuit representation could be written in a language such as Chisel, an HDL embedded in Scala, a statically typed general purpose programming language that supports both object-oriented programming and functional programming. In an example, a circuit representation may be a Chisel language program which may be executed by the computer to produce a circuit representation expressed in a FIRRTL data structure. In some implementations, a design flow of processing steps may be utilized to process the circuit representation into one or more intermediate circuit representations followed by a final circuit representation which is then used to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

In implementations, a system for increasing neural network accuracy includes a memory configured to store program instructions and one or more processors operably connected to the memory and configured to execute the program instructions to the cause the system to define a neural network configured for hybrid fixed-point computations and floating-point computations, wherein the neural network uses fixed-point input and output formats between layers of the neural network, perform a floating-point computation to generate an output in a floating-point format, and convert the output to a fixed-point format by rounding and clamping a value of the output.

In some implementations, the floating-point computation is configured to quantize a computational output. In some implementations, the computational output is from the fixed-point computations. In some implementations, the floating-point format is 32 bit floating-point format and the fixed-point format is 8 bit integer format. In some implementations, the floating-point format is 32 bit floating-point format and the fixed-point format is signed 8 bit integer format. In some implementations, the floating-point format is 32 bit floating-point format and the fixed-point format is unsigned 8 bit integer format. In some implementations, wherein for the convert, the one or more processors are further configured to execute the program instructions to the cause the system to clamp the value to a range defined by a 16 bit scalar register. In some implementations, a lower bound is defined by an 8 most significant bits in the 16 bit scalar register. In some implementations, an upper bound is defined by an 8 least significant bits in the 16 bit scalar register. In some implementations, wherein for the convert, the one or more processors are further configured to execute the program instructions to the cause the system to round the value that is clamped by the lower bound and the upper bound. In some implementations, wherein for the convert, the one or more processors are further configured to execute the program instructions to the cause the system to round the output and clamp the rounded output by an 8 bit lower bound and an 8 bit upper bound defined in a 16 bit scalar register to generate the value. In some implementations, a computational accuracy is increased as between a fixed-point computation and the floating-point computation for identified fixed-point computations. In some implementations, a computational cost is negligible as between a fixed-point computation and a floating-point computation for the identified fixed-point computations.

In implementations, a system for converting to a fixed-point output includes a memory configured to store program instructions and one or more processors operably connected to the memory and configured to execute the program instructions to the cause the system to round a floating-point input and clamp the floating-point input by a lower bound and an upper bound defined in a scalar register to generate the fixed-point output.

In some implementations, the floating-point input is a 32 bit floating-point input and the fixed-point output is an 8 bit output. In some implementations, the scalar register is a 16 bit scalar register and the upper bound is defined by an 8 least significant bits in the 16 bit scalar register and the lower bound is defined by an 8 most significant bits in the 16 bit scalar register. In some implementations, the floating-point input is 32 bit floating-point input and the fixed-point output is an 8 bit integer format. In some implementations, the floating-point input is 32 bit floating-point input and the fixed-point output is a signed 8 bit integer format. In some implementations, the floating-point input is 32 bit floating-point input and the fixed-point output is an unsigned 8 bit integer format.

In implementations, a method includes defining a neural network configured for hybrid fixed-point computations and floating-point computations, wherein the neural network uses fixed-point input and output formats between layers of the neural network, performing a floating-point computation to generate an output in a floating-point format, and converting the output to a fixed-point format by rounding and clamping a value of the output.

In some implementations, the method further includes rounding the output and clamping the rounded output by an 8 bit lower bound and an 8 bit upper bound defined in a 16 bit scalar register to generate the value.

In implementations, a non-transitory computer readable medium comprising a circuit representation that, when processed by a computer, is used to program or manufacture an integrated circuit comprising a memory and one or more processors operably connected to the memory. The one or more processors define a neural network configured for hybrid fixed-point computations and floating-point computations, wherein the neural network uses fixed-point input and output formats between layers of the neural network, perform a floating-point computation to generate an output in a floating-point format, and convert the output to a fixed-point format by rounding and clamping a value of the output.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. A system for increasing neural network accuracy, the system comprising:
a memory configured to store program instructions; and
one or more processors operably connected to the memory and configured to execute the program instructions to cause the system to:
define a neural network configured for hybrid fixed-point computations and floating-point computations, wherein the neural network uses fixed-point input and output formats between layers of the neural network;
perform a floating-point computation of the neural network to generate an output in a floating-point format; and
convert the output to a fixed-point format by rounding and clamping a value of the output.

2. The system of claim 1, wherein the floating-point computation is configured to quantize a computational output.

3. The system of claim 2, wherein the computational output is from fixed-point computations.

4. The system of claim 1, wherein the floating-point format is 32 bit floating-point format and the fixed-point format is 8 bit integer format.

5. The system of claim 1, wherein the floating-point format is 32 bit floating-point format and the fixed-point format is signed 8 bit integer format.

6. The system of claim 1, wherein the floating-point format is 32 bit floating-point format and the fixed-point format is unsigned 8 bit integer format.

7. The system of claim 1, wherein for the convert, the one or more processors are further configured to execute the program instructions to cause the system to:
clamp the value to a range defined by a 16 bit scalar register.

8. The system of claim 7, wherein a lower bound is defined by an 8 most significant bits in the 16 bit scalar register.

9. The system of claim 8, wherein an upper bound is defined by an 8 least significant bits in the 16 bit scalar register.

10. The system of claim 9, wherein for the convert, the one or more processors are further configured to execute the program instructions to cause the system to:
round the value that is clamped by the lower bound and the upper bound.

11. The system of claim 1, wherein for the convert, the one or more processors are further configured to execute the program instructions to cause the system to:
round the output; and
clamp the rounded output by an 8 bit lower bound and an 8 bit upper bound defined in a 16 bit scalar register to generate the value.

12. The system of claim 11, wherein a computational accuracy is increased as between a fixed-point computation and the floating-point computation for identified fixed-point computations.

13. The system of claim 12, wherein a computational cost is negligible as between a fixed-point computation and a floating-point computation for the identified fixed-point computations.

14. A system for converting to a fixed-point output, the system comprising:
a memory configured to store program instructions; and
one or more processors operably connected to the memory and configured to execute the program instructions to cause the system to:
round a floating-point input that represents a floating-point input value from a neural network computation; and
clamp the floating-point input by a lower bound and an upper bound defined in a scalar register to generate the fixed-point output.

15. The system of claim 14, wherein the floating-point input is a 32 bit floating-point input and the fixed-point output is an 8 bit output.

16. The system of claim 15, wherein the scalar register is a 16 bit scalar register and the upper bound is defined by an 8 least significant bits in the 16 bit scalar register and the lower bound is defined by an 8 most significant bits in the 16 bit scalar register.

17. The system of claim 14, wherein the floating-point input is 32 bit floating-point input and the fixed-point output is an 8 bit integer format.

18. The system of claim 14, wherein the floating-point input is 32 bit floating-point input and the fixed-point output is a signed 8 bit integer format.

19. The system of claim 14, wherein the floating-point input is 32 bit floating-point input and the fixed-point output is an unsigned 8 bit integer format.

20. A method comprising:
defining a neural network configured for hybrid fixed-point computations and floating-point computations, wherein the neural network uses fixed-point input and output formats between layers of the neural network;
performing a floating-point computation of the neural network to generate an output in a floating-point format; and
converting the output to a fixed-point format by rounding and clamping a value of the output.
